(19) United States
(12) Patent Application Publication
(10) Pub. No.: US 2020/0048472 A1
(43) Pub. Date: Feb. 13, 2020

(54) Radiation-Curable Hard Coating Composition

(71) Applicant: Essilor International, Charenton-le-Pont (FR)

(72) Inventor: Robert Valeri, Dallas, TX (US)

(21) Appl. No.: 16/534,558

(22) Filed: Aug. 7, 2019

(30) Foreign Application Priority Data
Aug. 8, 2018 (EP) 18306087.0

(51) Int. Cl. C09D 4/00; B29D 11/00; G02B 1/14

(52) U.S. Cl. CPC C09D 4/00; C08K 3/36; G02B 1/14; B29D 11/00865

(57) ABSTRACT

The UV-curable coating compositions disclosed herein are provided for use as coatings for plastic (organic glass) substrates, and ophthalmic lenses, in particular. The compositions may be applied by a variety of means, including spin coating and inkjet coating. The coating compositions exhibit abrasion resistance comparable to conventional thermally-cured sol-gel coatings.

### FIELD OF THE INVENTION

The present invention generally relates to UV-curable coating compositions for ophthalmic elements.

### BACKGROUND

Many optical article substrates include a hard coating applied over the base substrate to provide a transparent, abrasion resistant coating layer that protects the underlying optical substrate. Polysiloxane-based coatings are typically employed as abrasion-resistant hard coatings because of their high transparency and high abrasion resistance. These coatings are customarily formed by thermally curing a precursor composition that includes a hydrolysate of epoxyalkoxysilanes, silica, and a thermal curing catalyst. Thermal convection ovens are used to heat and cure the coatings, and curing times commonly exceed 1 hour.

In order to address the long cure times and high energy requirements of thermally-cured coating compositions, researchers have explored compositions that are curable by ultraviolet (UV) light. The use of ultraviolet light to cure hard coatings eliminates the high temperatures associated with thermal curing and reduces the likelihood of thermal substrate degradation.

Unlike most thermally-curable hard coating compositions, UV-curable compositions can be prepared in the absence of a diluting solvent. Current solvent-free, UV-curable ophthalmic substrate coatings do not offer the abrasion and scratch resistance that are provided by conventional solvent-based, thermally-cured coatings. There is a need in the industry for UV-curable hard coatings that can be cured with relative alarcity and exhibit abrasion resistance comparable to traditional thermally-cured coatings.

### SUMMARY

By combining non-hydrolyzed epoxy(alkoxy)silanes with dispersions of inorganic nanoparticles in acrylate monomers, the inventor has produced low viscosity coating compositions that can be cured by ultraviolet (UV) light. The resulting coatings exhibit abrasion resistance that is comparable to conventional solvent-borne sol-gel coatings.

Some aspects of the disclosure are directed to a photocurable coating composition comprising a mixture of at least one non-hydrolyzed epoxy(alkoxy)silane, at least one dispersion of inorganic nanoparticles and at least one acrylate, at least one acrylate binder or silane binder, and at least one free radical photoinitiator, cationic photoinitiator, or a combination thereof. In some embodiments, the composition does not comprise hydrolyzed epoxy(alkoxy)silane.

Some aspects of the disclosure are directed to a method for manufacturing an abrasion-resistant, hard-coated substrate. In some aspects, the method comprises coating an optical substrate with a photocurable coating composition comprising a mixture of: at least one non-hydrolyzed epoxy(alkoxy)silane; at least one dispersion of inorganic nanoparticles and at least one acrylate; at least one acrylate binder or silane binder; and at least one free radical photoinitiator, cationic photoinitiator, or a combination thereof; and curing the photocurable composition coating with UV irradiation. In some embodiments, the method does not comprise a hydrolysis step prior to curing. In some embodiments, the coating composition is dried to remove at least a part of the solvent prior to curing.

Some aspects of the disclosure are directed to an optical article having at least one main surface comprising a coating obtained by depositing a photocurable coating composition comprising a mixture of: at least one non-hydrolyzed epoxy(alkoxy)silane; at least one dispersion of inorganic nanoparticles and at least one acrylate; at least one acrylate binder or silane binder; and at least one free radical photoinitiator, cationic photoinitiator, or a combination thereof; and curing the photocurable composition coating. In some aspects, the method produces an optical article having a coating which exhibits a relative abrasion resistance of at least 2.5, when tested according to ASTM F735.

“Ophthalmic lens,” according to the disclosure, is defined as a lens adapted, namely for mounting in eyeglasses, whose function is to protect the eye and/or to correct vision. This lens can be an afocal, unifocal, bifocal, trifocal, or progressive lens. The ophthalmic lens may be corrective or un-corrective. Eyeglasses wherein ophthalmic lenses will be mounted could be either a traditional frame comprising two distinctive ophthalmic lenses, one for the right eye and one for the left eye, or with one ophthalmic lens that simultaneously faces the right and the left eyes, e.g., a mask, visor, helmet sight, or goggle. Ophthalmic lenses may be produced with traditional geometry as a circle or may be produced to be fitted to an intended frame.

Any embodiment of any of the disclosed compositions and/or methods can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

The term “substantially” and its variations are defined as being largely but not necessarily wholly what is specified as understood by one of ordinary skill in the art, and in one non-limiting embodiment substantially refers to ranges within 10%, within 5%, within 1%, or within 0.5%. The term “about” or “approximately” or “substantially unchanged” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims and/or the specification may mean “one,” but it is also consistent with the meaning of “one or more,” “at least one,” and “one or more than one.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. With respect to the transitional phase “consisting essentially of,” in one non-limiting aspect, a basic and novel characteristic of the compositions and methods disclosed in this specification includes a UV-curable coating composition that confers abrasion resistance to an optical article.

Other objects, features and advantages of the present invention will become apparent from the following detailed description. It should be understood, however, that the detailed description and the examples, while indicating specific embodiments of the invention, are given by way of illustration only. This summary of the invention does not list all necessary characteristics, and therefore, subcombinations of these characteristics may also constitute an aspect of the invention.

### BRIEF DESCRIPTION OF THE FIGURES

FIG. 1 is a graph depicting the relationship between abrasion resistance and nanoparticle/acrylate dispersion content of Examples 8 through 12.

FIG. 2 is a graph depicting the relationship between abrasion resistance and nanoparticle/acrylate dispersion content of Examples 13 through 19.

### DETAILED DESCRIPTION

Various features and advantageous details are explained more fully with reference to the non-limiting embodiments that are illustrated in the accompanying drawings and detailed in the following description. It should be understood, however, that the detailed description and the specific examples, while indicating embodiments, are given by way of illustration only, and not by way of limitation. Various substitutions, modifications, additions, and/or rearrangements will be apparent to those of ordinary skill in the art from this disclosure.

In the following description, numerous specific details are provided to provide a thorough understanding of the disclosed embodiments. One of ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present disclosure relates to UV-curable, abrasion-resistant coating compositions for ophthalmic articles. Commercial dispersions of functionalized SiO₂ in different acrylate monomers are available that contain up to 50% by weight SiO₂. The polymerizable acrylate monomers and the strength-enhancing silica particles can be combined with reactive monomers that bind to both the silica particles and acrylate monomers. The combination of silica/acrylate dispersions and reactive monomers can be used to provide silica-reinforced, solvent-free UV-curable compositions. The resulting hard coatings rival the abrasion resistance of thermally cured, solvent-borne sol-gel coatings.

The abrasion-resistant coating compositions disclosed herein include at least one non-hydrolyzed epoxy(alkoxy)silane, at least one dispersion of inorganic nanoparticles, at least one acrylate or silane binder, and at least one free radical photoinitiator, cationic photoinitiator, or a combination thereof.

By utilizing epoxy(alkoxy)silanes in the unhydrolyzed state, changes to viscosity can be minimized or eliminated, thereby providing coatings having improved stability and near-constant viscosity. When using unhydrolyzed epoxy(alkoxy)silanes, photoinitiators can simultaneously initiate the ring opening of the epoxy groups and catalyze the hydrolysis and condensation of the alkoxy groups with the strong Bronsted acid generated during photolysis. The condensation occurs between the alkoxy groups of the silane molecules and with the abundant silica particles, which provides a reinforcing effect and improves abrasion resistance. Acrylate content can be cured concomitantly with the epoxysilane, providing final cured compositions whose abrasion resistance is comparable to thermally cured sol-gel coatings. The coatings disclosed herein exhibit low viscosity, and can be applied by a variety of methods such as spin coating, inkjet coating, etc.

The non-hydrolyzed epoxy(alkoxy)silane has at least one hydrolyzable group directly linked to the silicon atom and at least one epoxy group. The epoxy group is a cyclic ether functional group, and is preferably an epoxide (oxirane). As used herein, the term “epoxide” represents a subclass of epoxy compounds containing a saturated three-membered cyclic ether. The non-hydrolyzed epoxy(alkoxy)silane is preferably γ-glycidoxypropyl trimethoxysilane. The epoxysilane preferably has from 2 to 6, more preferably 2 or 3 hydrolyzable functional groups directly linked to the silicon atom that lead to an OH group upon hydrolysis. Examples of hydrolyzable functional groups include but are not limited to alkoxy groups —O—R¹, wherein R¹ preferably represents a linear or branched alkyl or alkoxyalkyl group, preferably a C₁-C₄ alkyl group, acyloxy groups —O—C(O)R², wherein R² preferably represents an alkyl group, preferably a C₁-C₆ alkyl group, and more preferably a methyl or ethyl group, halogen groups such as Cl and Br, amino groups optionally substituted with one or two functional groups such as an alkyl or silane group, for example the NHSiMe₃ group, alkylenoxy groups such as the isopropenoxy group, and the hydroxyl group —OH. Examples of such epoxysilanes include γ-glycidoxypropyl triethoxysilane, γ-glycidoxypropyl trimethoxysilane (GLYMO), 2-(3,4-epoxycyclohexyl) ethyltrimethoxysilane, 3-glycidoxypropyl methyldiethoxysilane, 2-(3,4-epoxycyclohexyl) ethyltriethoxysilane. Among those silanes, γ-glycidoxypropyltrimethoxysilane (GLYMO) is preferred. The epoxy(alkoxy)silane is preferably provided and used in a non-hydrolyzed state.

When acrylate binder molecules are used in combination with the epoxy(alkoxy)silane, the coating composition may further comprise at least one photoinitiator, preferably from 0.5 to 20 parts by weight, relative to the coating composition. Such photoinitiators can be selected for example from haloalkylated aromatic ketones such as chloromethylbenzophenones; some benzoin ethers such as ethyl benzoin ether and isopropyl benzoin ether; dialkoxyacetophenones such as diethoxyacetophenone and α,α-dimethoxy-α-phenylacetophenone; hydroxyketones such as (1-[4-(2-hydroxyethoxy)-phenyl]-2-hydroxy-2-methyl-1-propan-1-one) (Irgacure® 2959 from CIBA), 1-hydroxy-cyclohexyl-phenyl-ketone (Irgacure® 184 from CIBA) and 2-hydroxy-2-methyl-1-phenylpropan-1-one (such as Darocur® 1173 sold by CIBA); alpha amino ketones, particularly those containing a benzoyl moiety, otherwise called alpha-amino acetophenones, for example 2-methyl 1-[4-phenyl]-2-morpholinopropan-1-one (Irgacure® 907 from CIBA), (2-benzyl-2-dimethyl amino-1-5 (4-morpholinophenyl)-butan-1-one (Irgacure® 369 from CIBA); monoacyl and bisacyl phosphine oxides and sulphides, such as phenylbis(2,4,6-trimethylbenzoyl)-phosphine oxide (Irgacure® 819 sold by CIBA); triacyl phosphine oxides; liquid photoinitiator blends (such as GENOCURE L™ sold by Rahn Usa Corp.) and mixtures thereof. Similarly, polyfunctional epoxy monomers may be used in combination with at least one cationic photoinitiator, which may be selected from a triarylsulfonium salt, a diaryliodonium salt or mixtures thereof, preferably a triarylsulfonium salt. The triarylsulfonium or diaryliodonium salts used in the present invention advantageously have counter-ions of low nucleophilicity and are preferably selected from triarylsulfonium hexafluoroantimonate, triarylsulfonium hexafluorophosphate, diaryliodonium hexafluoroantimonate and diaryliodonium hexafluorophosphate salts. Triarylsulfonium hexafluoroantimonate is available for example from Dow Chemical Company under the trademark CYRACURE™ UVI-6976 (50% by weight in propylene carbonate). Triarylsulfonium hexafluorophosphate is available for example from Dow Chemical Company under the trademark CYRACURE™ UVI-6992 (50% by weight in propylene carbonate). Diaryliodonium hexafluorophosphate is available for example from Ciba Specialty Chemicals, under the reference IRG-250, or from Aldrich under the reference 548014. Diaryliodonium hexafluoroantimonate is available for example from Sartomer Company under the reference SarCat CD 1012.

In some embodiments, the coating composition comprises at least one surfactant. The surfactant aids in wetting of the substrate, resulting in satisfactory cosmetics of the final coating. The surfactant can include for example poly(alkylene glycol)-modified polydimethylsiloxanes or polyheptamethylsiloxanes, or fluorocarbon-modified polysiloxanes. Preferred surfactants are fluorinated surfactant such as Novec® FC-4434 from 3M (non-ionic surfactant comprising fluoroaliphatic polymeric esters), Unidyne™ NS-9013, and EFKA® 3034 from CIBA (fluorocarbon-modified polysiloxane).

In some embodiments, the optical substrate is selected from the group consisting of thermoplastic, thermoset, and mineral optical substrates. Preferable optical substrates include, but are not limited to polycarbonate, poly(thio)urethanes, acrylics, and diethylene glycol bis(allyl carbonate) substrates. The substrate of the optical article, coated on at least one main face with a coating, may be a mineral or an organic glass, for instance an organic glass made from a thermoplastic or thermosetting plastic, generally chosen from transparent materials of ophthalmic grade used in the ophthalmic industry. Preferred classes of substrate materials are polycarbonates, polyamides, polyimides, polysulfones, copolymers of polyethylene therephthalate and polycarbonate, polyolefins such as polynorbornenes, resins resulting from polymerization or (co)polymerization of alkylene glycol bis allyl carbonates such as polymers and copolymers of diethylene glycol bis(allylcarbonate) (marketed, for instance, under the trade name CR-39® by the PPG Industries company), polycarbonates such as those derived from bisphenol A, (meth)acrylic or thio(meth)acrylic polymers and copolymers such as polymethyl methacrylate (PMMA), urethane and thiourethane polymers and copolymers, epoxy polymers and copolymers, episulfide polymers and copolymers.

Prior to depositing a coating, the surface of the substrate may be submitted to a physical or chemical surface activating and cleaning treatment, so as to improve the adhesion of the layer to be deposited, such as disclosed in WO 2013/013929, e.g., paragraphs [0066] through [0072] and [0090], which are incorporated by reference.

In some embodiments, the photocurable coating composition comprises 25 to 65 parts by weight of the non-hydrolyzed epoxy(alkoxy)silane. The at least one dispersion of inorganic nanoparticles and at least one acrylate comprises 20 to 60 parts by weight of the composition, in some embodiments. The inorganic nanoparticles are preferably metal-oxide nanoparticles, and more preferably silica nanoparticles.

In some embodiments, the photocurable coating composition comprises 5 to 20 parts by weight of the acrylate binder or silane binder. The acrylate binder or silane binder may be selected from the group consisting of 1,4-butanediol diacrylate, 1,6 hexanediol diacrylate, trimethylolpropane triacrylate, ethoxylated trimethylolpropane triacrylate, propoxylated glycerol triacrylate, alkoxylated pentaerythritol tetraacrylate, vinyltrimethoxysilane, or a combination thereof. In some aspects, the photoinitiator is present in an amount ranging from 0.5 to 20 parts by weight. The photoinitiator may be selected from the group consisting of a triarylsulfonium hexafluoroantimonate salt, a triarylsulfonium hexafluorophosphate salt, 2-hydroxy-2-methyl-1-phenyl-1-propanone, phenylbis(2,4,6-trimethylbenzoyl)-phosphine oxide, or a combination thereof. In some embodiments, the composition further comprises 0.05 to 1 part by weight of a surfactant. The coating composition may be provided with or without a solvent. In embodiments where a coating composition is provided in combination with a solvent, the coating composition may be dried to remove at least a part of the solvent prior to curing.

In some aspects, the coating is deposited on the optical substrate of the optical article and is preferably in direct contact with said substrate. The deposition is carried out using methods known in the art, preferably by spin-coating, spray-coating, 3D printing, roll-to-roll coating, or inkjet printing the UV-curable composition.

As used herein, a coating that is “on” a substrate/coating or which has been deposited “onto” a substrate/coating is defined as a coating that (i) is positioned above the substrate/coating, (ii) is not necessarily in contact with the substrate/coating, that is to say one or more intermediate coating(s) may be interleaved between the substrate/coating and the relevant coating (however, it does preferably contact said substrate/coating), and (iii) does not necessarily completely cover the substrate/coating. When a first coating is said to be located under a second coating, it should be understood that the second coating is more distant from the substrate than the first coating.

### A. Evaluation of Cured Coating Abrasion Resistance

A sand Bayer abrasion resistance test was performed on each coated lens, in accordance with the ASTM F735 standard. The sand Bayer Test consists of comparing the abrasion generated on a test specimen against an ISO Reference Lens (uncoated CR-39 lens). Both lenses are mounted in a special Bayer test lens holder that allows the curvature of the lenses to protrude above the bottom of the tray. After the specimens are covered with sand (abrasive media), the tray is reciprocated in a back-and-forth (to-and-fro) motion a distance of 4 inches, at 150 cycles per minute for 4 minutes.

After the abrasion cycle, the abrasion of the two lenses are compared. The degree of abrasion is measured by the amount of change in haze as measured by a hazemeter. A ratio that compares the increase in haze of the test lens to that of the ISO Reference Lens provides a measure of how much more abrasion resistant the test lens is compared to an uncoated lens.

### B. Simulated Ageing

Some examples were subjected to the Q-sun test to simulate the effects of sunlight exposure upon the coated optical article. The Q-sun test consists of placing the coated optical articles in a Q-sun® Xe-3 xenon chamber, which reproduces full spectrum sunlight, at a relative humidity of 20% (±5%) and at a temperature of 23° C. (±5° C.), and exposing their coated side to the light for 40 or 80 hours.

### C. N×10 Blows Test

The N×10 Blows Test was used to evaluate the adhesion of a subsequent anti-reflection coating to the UV hard coating. The test is performed in accordance with ISTM 02-011. Briefly, a sample to be tested is placed in a clamp and covered with a selvyt cloth impregnated with isopropyl alcohol. An eraser positioned on a holder moving in translation is put in contact with the cloth. The eraser is pressed down (force=60 Newtons) on the selvyt cloth placed in contact with the lens. The test consists in the determination, for each sample, of the number of cycles required to cause a defect to appear in the subsequent anti-reflection coating.

### D. RC02 Test

The RC02 Test was used to evaluate corrosion resistance of a subsequent anti-reflection coating to the UV coating. The test is performed in accordance with ISTM 02-020. Briefly, lenses are half-immersed in a salt water solution of 200 g/l at 50° C. for a period of 20 minutes. The convex and concave sides of the lens are visually inspected for variation in the immersed part of the lens of the color, the level of reflection and the presence of possible attacks. An attack defect is characterized by a reflection level higher or equal of those of uncoated substrate, coming from partial or total baring of the anti-reflection coating stack. Attack defects located at less than 2 mm from the edge are not taken account in the notation, exception for edged lenses after antireflection coating for which all the surface is analyzed. Attack defects having area less than 1 mm² are not taken account.

### EXAMPLES

### Examples 1-4

A series of solvent-free UV-curable coating compositions were prepared. Typical solvent-free UV-cured hard coatings devoid of SiO₂ have sand Bayer abrasion values ranging from less than 1.0 to about 2.0. Examples 1 and 2 in Table 1 below demonstrate that sand Bayer values greater than 2.0 can be achieved using high SiO₂ loading dispersed in different acrylate monomers (component amounts in Tables below reported in wt. percentage). In Examples 3 and 4, the proportion of unhydrolyzed epoxy(alkoxy)silane to silica acrylate dispersion was increased over the proportions in Examples 1 and 2. Examples 3 and 4 show that abrasion resistance can be enhanced by increasing the proportion of unhydrolyzed epoxy(alkoxy)silane to silica acrylate dispersion. Sand Bayer values greater than 3.0 were achieved by adjusting this ratio.

TABLE 1
Examples 1-4, Compositions and Properties

| | Exam- | Exam- | Exam- | Exam- |
|---|---|---|---|---|
| | ple 1 | ple 2 | ple 3 | ple 4 |
| Component | | | | |
| γ-glycidoxypropyl | 34.89 | 35.13 | 48.29 | 48.29 |
| trimethoxysilane | | | | |
| Vinyltrimethoxysilane | 8.72 | 8.78 | 9.66 | — |
| 1,4-butanediol diacrylate | — | — | — | 9.66 |
| 50% SiO₂ dispersed in | 52.33 | — | — | — |
| trimethylol propane | | | | |
| triacrylate | | | | |
| 50% SiO₂ dispersed in | — | 52.70 | 38.33 | 38.63 |
| ethoxylated pentaerythritol | | | | |
| tetraacrylate | | | | |
| Triarylsulfonium | 2.09 | 1.58 | 1.81 | 1.81 |
| hexafluoroantimonate salts, | | | | |
| mixed | | | | |
| Triarylsulfonium | 0.70 | 0.527 | 0.604 | 0.604 |
| hexafluorophosphate salts, | | | | |
| mixed | | | | |
| 2-hydoxy-2-methyl-1-phenyl- | 0.872 | 0.824 | 0.657 | 0.657 |
| 1-propanone | | | | |
| (photoinitiator) | | | | |
| phenylbis(2,4,6- | 0.218 | 0.220 | 0.164 | 0.164 |
| trimethylbenzoyl)-phosphine | | | | |
| oxide | | | | |
| (photoinitiator) | | | | |
| Surfactant | 0.174 | 0.176 | 0.193 | 0.193 |
| (mixture of fluoro- | | | | |
| surfactants) | | | | |
| Total | 100.0 | 100.0 | 100.0 | 100.0 |
| Performance | | | | |
| Sand Bayer | 2.3 | 2.5 | 3.3 | 3.4 |
| ASTM Haze | 0.88 | 0.25 | 0.19 | 0.20 |
| Trans. AVL | 91.1 | 91.9 | 92.3 | 92.3 |

### Examples 5-7

Abrasion resistance, haze, and transmittance were examined after the coatings were cured with UV only and UV and infrared (IR) irradiation. Example 5 includes a pre-hydrolyzed epoxy(alkoxy)silane, UV photoinitiators, and the condensation catalyst aluminum acetylacetonate. Examples 6 and 7 include unhydrolyzed epoxy(alkoxy)silane, cationic photoinitiators, and no metal catalyst. Despite the additional heat provided by IR treatment, Example 5, having the pre-hydrolyzed epoxy(alkoxy)silane, performs significantly worse in abrasion resistance than either UV-only Example 6 or Example 7. Examples 6 and 7 do not include a metal catalyst and rely on cationic photoinitiators to open the epoxy(alkoxy)silane epoxy ring and catalyze hydrolysis and condensation of the alkoxy groups.

TABLE 2
Examples 5-7, Compositions and Properties

| | Example 5 | Example 6 | Example 7 |
|---|---|---|---|
| Component | | | |
| Hydrolyzed epoxy(alkoxy)silane | 47.87 | — | — |
| (Hydrolyzed | | | |
| glycidoxypropyltrimethoxysilane) | | | |
| Non-hydrolyzed epoxy(alkoxy)silane | — | 48.05 | 48.05 |
| (γ-glycidoxypropyl | | | |
| trimethoxysilane) | | | |
| Nanoparticle/acrylate dispersion | 38.30 | 38.44 | 38.44 |
| (50% SiO₂ dispersed in ethoxylated | | | |
| pentaerythritol tetraacrylate) | | | |
| Silane binder (vinyltrimethoxysilane) | 9.57 | 9.61 | — |
| Acrylate binder | — | — | 9.61 |
| (1,4-butanediol diacrylate) | | | |
| Catalyst (aluminum acetylacetonate) | 0.48 | — | — |
| Photoinitiator (triarylsulfonium | 2.15 | 2.15 | 2.15 |
| hexafluoroantimonate salts, mixed) | | | |
| Photoinitiator (triarylsulfonium | 0.718 | 0.718 | 0.718 |
| hexafluorophosphate salts, mixed) | | | |
| Photoinitiator (2-hydroxy-2-methyl-1- | 0.613 | 0.654 | 0.656 |
| phenyl-1-propanone) | | | |
| Photoinitiator (phenylbis(2,4,6- | 0.153 | 0.163 | 0.164 |
| trimethylbenzoyl)-phosphine oxide) | | | |
| Surfactant (mixture of fluoro- | 0.144 | 0.192 | 0.192 |
| surfactants) | | | |
| Total | 100.00 | 100.00 | 100.00 |
| Viscosity (25° C.) | 8.1 cps | 11.0 cps | 14.1 cps |
| Specific Gravity | 1.196 | 1.194 | 1.200 |
| Surface Tension | 30.4 | 27.5 | 28.9 |
| Performance | | | |
| (average of 3 lenses) | | | |
| Sand Bayer (UV only) | 2.3 | 3.4 | 3.5 |
| ASTM Haze (UV only) | 0.18 | 0.28 | 0.23 |
| Trans. AVL (UV only) | 92.50 | 92.50 | 92.50 |
| Q-Sun adhesion, 0 hrs | Pass | Pass | Pass |
| Q-Sun adhesion, 40 hrs | Pass | Pass | Pass |
| Q-Sun adhesion, 80 hrs | Pass | Pass | Pass |
| Coating Thickness (μm) | 3.95 | 3.98 | 4.38 |
| Sand Bayer (UV + IR) | 2.8 | 3.5 | 3.6 |
| ASTM Haze (UV + IR) | 0.20 | 0.23 | 0.23 |
| Transmission AVL (UV + IR) | 92.50 | 92.50 | 92.50 |

### Examples 8-12

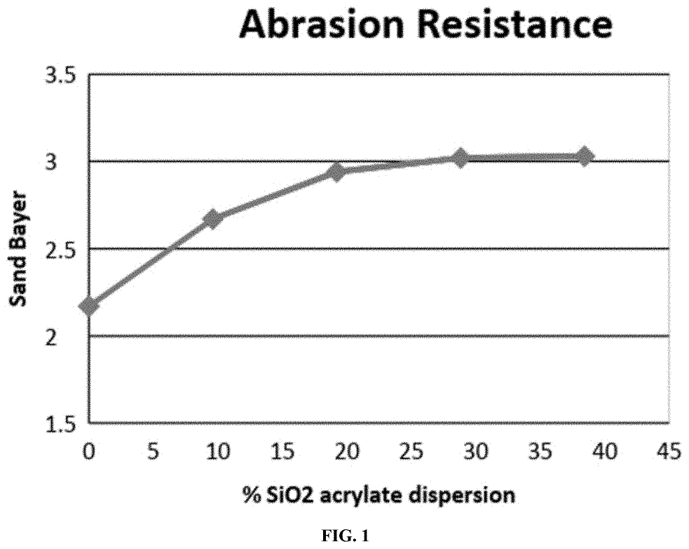

In Examples 8 through 12 various nanoparticle/acrylate dispersion amounts were examined. As the dispersion amount increases from Example 12 through Example 8, the abrasion resistance increases until a maximum abrasion resistance of 3.0 is reached for the two Examples having the highest nanoparticle/acrylate dispersion content (Examples 8 and 9). The relationship between abrasion resistance and nanoparticle/acrylate dispersion content is depicted in FIG. 1.

TABLE 3
Examples 8-12, Compositions and Properties

| | Exam- | Exam- | Exam- | Exam- | Exam- |
|---|---|---|---|---|---|
| | ple 8 | ple 9 | ple 10 | ple 11 | ple 12 |
| Component | | | | | |
| Non-hydrolyzed | 48.05 | 48.05 | 48.05 | 48.05 | 48.05 |
| epoxy(alkoxy)silane | | | | | |
| (γ-glycidoxypropyl | | | | | |
| trimethoxysilane) | | | | | |
| Nanoparticle/acrylate | 38.44 | 28.83 | 19.22 | 9.61 | — |
| dispersion (50% SiO₂ in | | | | | |
| ethoxylated | | | | | |
| pentaerythritol | | | | | |
| tetraacrylate) | | | | | |
| Acrylate binder | 9.61 | 9.61 | 9.61 | 9.61 | 9.61 |
| (1,4 butanediol | | | | | |
| diacrylate) | | | | | |
| Acrylate binder | — | 9.61 | 19.22 | 28.83 | 38.44 |
| (ethoxylated | | | | | |
| pentaerythritol | | | | | |
| tetraacrylate) | | | | | |
| Photoinitiator | 2.16 | 2.16 | 2.16 | 2.16 | 2.16 |
| (triarylsulfonium | | | | | |
| hexafluoroantimonate | | | | | |
| salts, mixed) | | | | | |
| Photoinitiator | 0.720 | 0.720 | 0.720 | 0.720 | 0.720 |
| (triarylsulfonium | | | | | |
| hexafluorophosphate | | | | | |
| salts, mixed) | | | | | |
| Photoinitiator | 0.654 | 0.654 | 0.654 | 0.654 | 0.654 |
| (2-hydroxy-2-methyl- | | | | | |
| 1-phenyl-1-propanone) | | | | | |
| Photoinitiator | 0.163 | 0.163 | 0.163 | 0.163 | 0.163 |
| (phenylbis(2,4,6- | | | | | |
| trimethylbenzoyl)- | | | | | |
| phosphine oxide) | | | | | |
| Surfactant (mixture of | 0.192 | 0.192 | 0.192 | 0.192 | 0.192 |
| fluoro-surfactants) | | | | | |
| Total | 100.00 | 100.00 | 100.00 | 100.00 | 100.00 |
| Performance | | | | | |
| Sand Bayer | 3.0 | 3.0 | 2.9 | 2.7 | 2.2 |
| HSW | 3 | 3 | 5 | 5 | 3 |
| Haze | 0.21 | 0.14 | 0.14 | 0.15 | 0.15 |
| Transmission | 92.2 | 92.2 | 92.2 | 92.1 | 92.1 |

### Examples 13-19

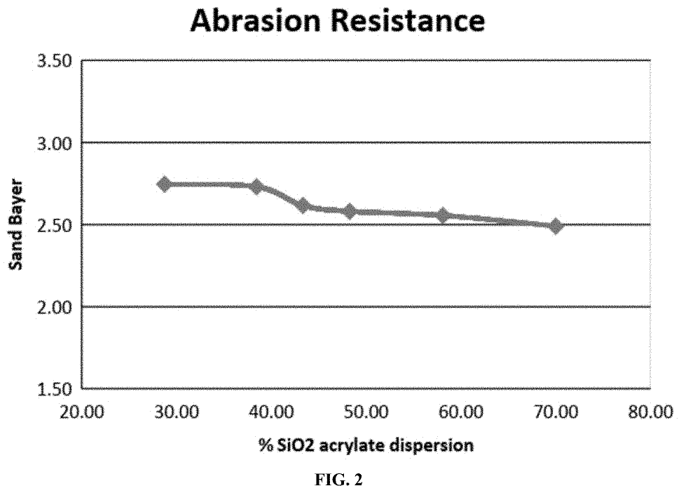

Examples 13-19 were prepared with increasing amounts of the nanoparticle/acrylate dispersion. There was a concomitant decrease in the proportion of non-hydrolyzed epoxy(alkoxy)silane across Examples 13-19. Increasing the proportion of nanoparticle/acrylate dispersion resulted in a slight decrease in abrasion resistance (FIG. 2) and increased brittleness. Example 19 included the highest nanoparticle/acrylate dispersion amount (80%). The high nanoparticle/acrylate dispersion content caused the coating to craze during UV cure. Both epoxy(alkoxy)silane also plays a role in abrasion resistance and the optimum concentration of the SiO2 acrylate dispersion depends on the co-monomers chosen.

TABLE 4-1
Examples 13-16, Compositions and Properties

| | Exam- | Exam- | Exam- | Exam- |
|---|---|---|---|---|
| | ple 13 | ple 14 | ple 15 | ple 16 |
| Component | | | | |
| Non-hydrolyzed | 52.70 | 48.02 | 43.34 | 38.61 |
| epoxy(alkoxy)silane | | | | |
| (γ-glycidoxypropyl | | | | |
| trimethoxysilane) | | | | |
| Nanoparticle/acrylate | 28.75 | 38.44 | 43.34 | 48.26 |
| dispersion | | | | |
| (50% SiO₂ in ethoxylated | | | | |
| pentaerythritol tetraacrylate) | | | | |
| Acrylate binder | 14.37 | 9.63 | 9.63 | 9.65 |
| (1,4 butanediol diacrylate) | | | | |
| Photoinitiator | 2.372 | 2.165 | 1.950 | 1.738 |
| (triarylsulfonium | | | | |
| hexafluoroantimonate | | | | |
| salts, mixed) | | | | |
| Photoinitiator | 0.791 | 0.722 | 0.650 | 0.579 |
| (triarylsulfonium | | | | |
| hexafluorophosphate | | | | |
| salts, mixed) | | | | |
| Photoinitiator (2-hydroxy-2- | 0.657 | 0.659 | 0.715 | 0.772 |
| methyl-1-phenyl-1-propanone) | | | | |
| Photoinitiator (phenylbis(2,4,6- | 0.164 | 0.165 | 0.179 | 0.193 |
| trimethylbenzoyl)-phosphine | | | | |
| oxide) | | | | |
| Surfactant (mixture of fluoro- | 0.192 | 0.192 | 0.193 | 0.193 |
| surfactants) | | | | |
| Total | 100.00 | 100.00 | 100.00 | 100.00 |
| Performance | | | | |
| (average of 3 lenses) | | | | |
| Sand Bayer (UV only) | 2.8 | 2.7 | 2.6 | 2.6 |
| ASTM Haze | 0.15 | 0.24 | 0.15 | 0.14 |
| Trans. AVL | 92.15 | 92.10 | 92.15 | 92.10 |

TABLE 4-2
Examples 17-19, Compositions and Properties

| | Exam- | Exam- | Exam- |
|---|---|---|---|
| | ple 17 | ple 18 | ple 19 |
| Component | | | |
| Non-hydrolyzed | 33.88 | 26.00 | 16.00 |
| epoxy(alkoxy)silane | | | |
| (γ-glycidoxypropyl | | | |
| trimethoxysilane) | | | |
| Acrylate binder | 4.84 | — | — |
| (1,4 butanediol diacrylate) | | | |
| Nanoparticle/acrylate | 58.08 | 70.00 | 80.00 |
| dispersion | | | |
| (50% SiO₂ in ethoxylated | | | |
| pentaerythritol tetraacrylate) | | | |
| Photoinitiator | 1.525 | 1.200 | 0.960 |
| (triarylsulfonium | | | |
| hexafluoroantimonate | | | |
| salts, mixed) | | | |
| Photoinitiator | 0.508 | 0.400 | 0.720 |
| (triarylsulfonium | | | |
| hexafluorophosphate | | | |
| salts, mixed) | | | |
| Photoinitiator | 0.774 | 1.760 | 2.272 |
| (2-hydroxy-2-methyl-1-phenyl- | | | |
| 1-propanone) | | | |
| Photoinitiator (phenylbis(2,4,6- | 0.194 | 0.440 | 0.568 |
| trimethylbenzoyl)-phosphine | | | |
| oxide) | | | |
| Surfactant (mixture of fluoro- | 0.194 | 0.200 | 0.200 |
| surfactants) | | | |
| Total | 100.00 | 100.00 | 100.00 |
| Performance | | | |
| (average of 3 lenses) | | | |
| Sand Bayer (UV only) | 2.6 | 2.5 | Crazed |
| ASTM Haze | 0.19 | 0.24 | Crazed |
| Trans. AVL | 92.10 | 92.00 | Crazed |

Based on the findings above, optimum performance with respect to abrasion resistance is obtained using a range of unhydrolyzed epoxy(alkoxy)silane from 25% to 65% of the total solids together with an acrylated silica dispersion ranging from 10% to 70% of the total solids and a range from 5% to 20% of a reactive monomer together with a mixture of cationic photoinitiators to achieve optimum through cure and surface cure of the epoxy(alkoxy)silane and a mixture of free radical photoinitiators to achieve optimum through cure and surface cure of the acrylates.

TABLE 5
Component Ranges Providing Enhanced Abrasion Resistance

| | | Minimum | Maximum |
|---|---|---|---|
| Component | Component Type | (wt. %) | (wt. %) |
| γ-Glycidoxypropyl | Non-hydrolyzed | 25 | 65 |
| trimethoxysilane | epoxy(alkoxy)silane | | |
| 50% SiO₂ dispersed in | Dispersion of | 10 | 70 |
| ethoxylated | inorganic nanoparticles | | |
| pentaerythritol | and at least | | |
| tetraacrylate | one acrylate | | |
| 1,4 butanediol diacrylate | Silane binder | 5 | 20 |
| Triarylsulfonium | Photoinitiator | 0.4 | 6 |
| hexafluoroantimonate | | | |
| salts, mixed | | | |
| Triarylsulfonium | Photoinitiator | 0.4 | 6 |
| hexafluorophosphate | | | |
| salts, mixed | | | |
| 2-hydroxy-2-methyl-1- | Photoinitiator | 0.30 | 3.5 |
| phenyl-1-propanone | | | |
| phenylbis(2,4,6- | Photoinitiator | 0.30 | 3.5 |
| trimethylbenzoyl)- | | | |
| phosphine oxide | | | |
| Mixture of | Surfactant | 0 | 1.0 |
| fluoro-surfactants | | | |

### Examples 20 and 21

Examples 20 and 21 in Table 6 below were prepared using the component ranges (from Table 5) that were determined to provide enhanced abrasion resistance.

TABLE 6
Examples 20 and 21, Compositions and Properties

| | Exam- | Exam- |
|---|---|---|
| | ple 20 | ple 21 |
| Component | % | % |
| Non-hydrolyzed epoxy(alkoxy)silane | 52.71 | 48.05 |
| (γ-glycidoxypropyltrimethoxysilane) | | |
| Acrylate binder (1,4 butanediol diacrylate) | 14.37 | 9.61 |
| Nanoparticle/acrylate dispersion (50% SiO₂ in | 28.75 | 38.44 |
| ethoxylated pentaerythritol tetraacrylate) | | |
| Photoinitiator (triarylsulfonium | 2.37 | 2.16 |
| hexafluoroantimonate salts, mixed) | | |
| Photoinitiator (triarylsulfonium | 0.79 | 0.72 |
| hexafluorophosphate salts, mixed) | | |
| Photoinitiator | 0.66 | 0.65 |
| (2-hydroxy-2-methyl-1-phenyl-1-propanone) | | |
| Photoinitiator | 0.16 | 0.16 |
| (phenylbis(2,4,6-trimethylbenzoyl)-phosphine | | |
| oxide) | | |
| Surfactant (mixture of fluoro-surfactants) | 0.19 | 0.19 |
| Total | 100.0 | 100.0 |

Table 7 below shows the performance of example 20 compared to that of a thermally cured production sol-gel coating. The compositions disclosed herein represent the first UV-curable coatings that display abrasion-resistant performance comparable conventional thermally-cured sol coatings.

TABLE 7
100% Solids UV Hard Coating vs. Solvent-borne Sol-gel Thermally Cured Coating

| | Lens # | | | | | | | |
|---|---|---|---|---|---|---|---|---|
| | 1 | 2 | 3 | Ave. | 1 | 2 | 3 | Ave. |
| | Example 20/ | | | | Production Sol-Gel Hard | | | |
| | UV Hard Coat | | | | Coating | | | |
| Sand Bayer | 2.8 | 2.9 | 2.9 | 2.9 | 3.6 | 3.6 | 3.7 | 3.6 |
| ASTM Haze | 0.15 | 0.16 | 0.15 | 0.15 | 0.09 | 0.09 | 0.10 | 0.09 |
| Transmission | 92.0 | 92.0 | 92.0 | 92.0 | 92.7 | 92.7 | 92.7 | 92.7 |
| Hand Steel Wool | 3 | 3 | 3 | 3 | 1 | 1 | 1 | 1 |
| Thickness | 3.95 | 3.95 | 3.86 | 3.92 | 3.03 | 2.95 | 3.00 | 2.99 |
| 0 hr Q-Sun adhesion | Pass | Pass | Pass | Pass | Pass | Pass | Pass | Pass |
| 40 hr Q-Sun adhesion | Pass | Pass | Pass | Pass | Pass | Pass | Pass | Pass |
| 80 hr Q-Sun adhesion | Pass | Pass | Pass | Pass | Pass | Pass | Pass | Pass |
| | Crizal FUV AR Coated on | | | | Crizal FUV AR Coated on | | | |
| | Example 20 | | | | Sol-Gel Hard Coat | | | |
| Sand Bayer | 4.8 | 5.1 | 5.3 | 5.1 | 5.2 | 5.5 | 5.4 | 5.4 |
| ASTM Haze | 0.13 | 0.09 | 0.46* | 0.23 | 0.06 | 0.06 | 0.05 | 0.06 |
| Transmission AVL | 97.7 | 97.8 | 97.4 | 97.6 | 98.2 | 98.2 | 98.2 | 98.2 |
| Hand Steel Wool | 3 | 3 | 3 | 3 | 3 | 3 | 3 | 3 |
| N × 10 Blows | N > 12 | N > 12 | N > 12 | N > 12 | N > 12 | N > 12 | N > 12 | N > 12 |
| RCO2 | 1/2 | 1/2 | 1/2 | 1/2 | 1/2 | 1/2 | 1/2 | 1/2 |

*AR = anti-reflective

In summary, the disclosure provides coatings for plastic (organic glass) substrates, and ophthalmic lenses, in particular. As shown by the data in Table 7, the present coating compositions exhibit abrasion resistance comparable to conventional thermally-cured sol-gel coatings. The compositions may be applied by a variety of means, including spin coating and inkjet coating.

The claims are not to be interpreted as including means-plus- or step-plus-function limitations, unless such a limitation is explicitly recited in a given claim using the phrase(s) “means for” or “step for,” respectively.

1. A photocurable coating composition comprising a mixture of:
a) at least one non-hydrolyzed epoxy(alkoxy)silane;
b) at least one dispersion of inorganic nanoparticles and at least one acrylate;
c) at least one acrylate binder or silane binder; and
d) at least one free radical photoinitiator, cationic photoinitiator, or a combination thereof;
wherein:
the composition does not comprise hydrolyzed epoxy(alkoxy)silane;
the composition comprises 25 to 65 parts by weight of the non-hydrolyzed epoxy(alkoxy)silane; and
the composition comprises 20 to 60 parts by weight of the at least one dispersion of inorganic nanoparticles and at least one acrylate.

2. The composition of claim 1, wherein the inorganic nanoparticles are silica nanoparticles.

3. The composition of claim 1, wherein the composition comprises 5 to 20 parts by weight of the acrylate binder or silane binder.

4. The composition of claim 3, wherein the acrylate binder or silane binder is selected from the group consisting of 1,4-butanediol diacrylate, 1,6 hexanediol diacrylate, trimethylolpropane triacrylate, ethoxylated trimethylolpropane triacrylate, propoxylated glycerol triacrylate, alkoxylated pentaerythritol tetraacrylate, vinyltrimethoxysilane, or a combination thereof.

5. The composition of claim 1, wherein the composition comprises 0.5 to 20 parts by weight of photoinitiator.

6. The composition of claim 5, wherein the photoinitiator is selected from the group consisting of a triarylsulfonium hexafluoroantimonate salt, a triarylsulfonium hexafluorophosphate salt, 2-hydroxy-2-methyl-1-phenyl-1-propanone, phenylbis(2,4,6-trimethylbenzoyl)-phosphine oxide, or a combination thereof.

7. The composition of claim 1, wherein the composition further comprises 0.05 to 1 part by weight of a surfactant.

8. The composition of claim 1, wherein the composition further comprises a solvent.

9. A method for manufacturing an abrasion-resistant, hard-coated substrate, the method comprising:
coating an optical substrate with a photocurable coating composition comprising a mixture of:
a) at least one non-hydrolyzed epoxy(alkoxy)silane;
b) at least one dispersion of inorganic nanoparticles and at least one acrylate;
c) at least one acrylate binder or silane binder; and
d) at least one free radical photoinitiator, cationic photoinitiator, or a combination thereof;
wherein:
the composition comprises 25 to 65 parts by weight of the non-hydrolyzed epoxy(alkoxy)silane; and
the composition comprises 20 to 60 parts by weight of the at least one dispersion of inorganic nanoparticles and at least one acrylate; and
curing the photocurable composition coating with UV irradiation;
wherein the method does not comprise a hydrolysis step prior to curing.

10. The method of claim 9, wherein the optical substrate is selected from the group consisting of thermoplastic, thermoset, and mineral optical substrates.

11. The method of claim 10, wherein the optical substrate is selected from the group consisting of polycarbonate, poly(thio)urethanes, acrylics, and diethylene glycol bis(allyl carbonate).

12. The method of claim 9, further comprising the step of drying the photocurable composition coating prior to curing.

13. An optical article having at least one main surface comprising a coating obtained by:
depositing a photocurable coating composition comprising a mixture of:
a) at least one non-hydrolyzed epoxy(alkoxy)silane;
b) at least one dispersion of inorganic nanoparticles and at least one acrylate;
c) at least one acrylate binder or silane binder; and
d) at least one free radical photoinitiator, cationic photoinitiator, or a combination thereof
wherein:
the composition comprises 25 to 65 parts by weight of the non-hydrolyzed epoxy(alkoxy)silane; and
the composition comprises 20 to 60 parts by weight of the at least one dispersion of inorganic nanoparticles and at least one acrylate; and
curing the photocurable composition coating to produce an optical article having a coating which exhibits a relative abrasion resistance of at least 2.5, when tested according to ASTM F735.
